(19) United States
(12) Patent Application Publication
(10) Pub. No.: US 2021/0221564 A1
(43) Pub. Date: Jul. 22, 2021

(54) MODULAR CONTAINER

(71) Applicant: Jeffrey B. Ramsay, Pittsburgh, PA (US)

(72) Inventor: Jeffrey B. Ramsay, Pittsburgh, PA (US)

(21) Appl. No.: 17/154,148

(22) Filed: Jan. 21, 2021

Related U.S. Application Data
(60) Provisional application No. 62/963,768, filed on Jan. 21, 2020.

(51) Int. Cl. B65D 25/22; A01G 9/02

(52) U.S. Cl. CPC B65D 25/22; A01G 9/024

(57) ABSTRACT

A container with integrated channels that provide rapid and simple attachment and removal of interchangeable, modular accessories to the container's exterior. The accessories facilitate attachment of devices to the container. The accessories, when attached to the channels, provide various possible methods to fix the container to any structure or supporting device in any environment.

### CROSS-REFERENCE TO RELATED APPLICATION

This application claims priority to U.S. Provisional Application Ser. No. 62/963,768, filed Jan. 21, 2020, which application is incorporated by reference herein in its entirety.

### BACKGROUND OF THE INVENTION

### Field of the Invention

The present invention generally relates to a modular container/pot/vessel/planter/vase/bowl/bucket/etc., hereinafter “container”, having at least one channel for facilitating quick attachment and removal of various accessories and/or hardware. The invention incorporates these channels/slots/tracks/grooves, hereinafter “channel(s)”, which accept a wide variety of attachments, including various types of hardware used on their own or to attach a wide variety of accessories to the container for additional functionality and/or decorating purposes. Accessories can be attached by utilizing the channel(s) present in the body of invention. The channel(s) can be in various quantities and locations, including on the bottom as well as on the sides of the container depending upon the various embodiments of the invention. Additionally, one embodiment of the present invention includes at least one receptacle on the bottom of the container to accept accessories and/or hardware. In one embodiment, the receptacle(s) will be threaded or can contain female threaded hardware, such as permanent threaded inserts.

### Description of the Related Art

The container of the present invention facilitates the attachment of accessories to the container as well as enabling the container to be securely attached to structures (such as buildings, walls, frames, and shelves) and vehicles (such as trucks, planes, and boats). The container of the present invention, with or without attachments, can be used indoors and/or outdoors. Compatible accessories allow for hanging the container on any railing, fencing, posts, siding or walls of a house, a building, etc. and for holding devices. When used indoors, often the container is placed onto existing shelving, tables, desks or other household furniture for decorative or utilitarian purposes.

The objective of the invention is to provide means of making it easier to attach/affix accessories to the container and to quickly install and remove the container to and from existing structures or in-process final assembly supports, such as window boxes, posts, steps, patio and deck structures, docks, railings, and/or a wall, a house or building. During indoor use, office spaces and manufacturing floors may use the containers to hold various contents while easily being attached to desks, writing boards, walls, shelving, etc. The related field contains no descriptions of modular containers according to the present design that facility easy attachment of accessories and/or hardware and also can easily be mounted or secured to a support structure.

### BRIEF SUMMARY OF THE INVENTION

The present invention is a container that allows for the mounting of hardware and/or accessories onto the container and/or which can itself be wall mounted, placed onto rails, secured to the floor, and/or on castors to be used for mobility, as floor standoffs or as a floor stand, or attached to a railing, window, sill or other interior or exterior feature of a building. The container according to the present invention has slotted channel(s) in a circumferential sidewall with one or more optional panels that define varying cross-sectional shapes and/or the bottom of the body that optionally can accept hardware, such as T-shaped bolts and nuts for the mounting of various accessories or the channels can accept accessories directly. The body is not limited to a certain size or shape and can be any size or shape container.

One embodiment of the present invention is a container that has a top with an opening, a bottom and a circumferential sidewall, wherein the circumferential sidewall has a top edge, a bottom edge and at least one channel extending up the circumferential sidewall.

A second embodiment of the invention is a container system comprising a container, having a top with an opening, a bottom and a circumferential sidewall, and an attachment of a predetermined size and shape to connect to the at least one channel. In this embodiment, the circumferential sidewall has a top edge, a bottom edge and at least one channel extending up the circumferential sidewall.

The present invention also encompasses a container connector device for connecting two containers. The device comprises a body section and two opposing ends on the body section, each opposing end having a predetermined size and shape to connect to a channel in a sidewall of a container. An alternative structure for the container connector device has at least one of the two opposing ends movably connected to the body such that the at least one of the two opposing ends can be operated to pull the attached container closer to the body of the container connector device. A third structure for the container connector device has the at least one movably connected end of the two opposing ends that is a threaded T-bolt that connects to the body section through a threaded nut structure in the body.

### BRIEF DESCRIPTION OF THE SEVERAL VIEWS OF THE DRAWINGS

For the purpose of facilitating understanding of the invention, the accompanying drawings and description illustrate preferred embodiments thereof, from which the invention, various embodiments of its structures, construction and method of operation, and many advantages, may be understood and appreciated. The accompanying drawings are hereby incorporated by reference.

FIG. 1 is a perspective view of a modular container according to the present invention with a holding bracket attached to the container;

FIG. 2 is a perspective front (or side) view of the modular container of FIG. 1 depicting a threaded thumb wheel holding a holding bracket to the channel;

FIG. 3 is a cross-section A-A of FIG. 2, depicting the channel geometry;

FIG. 4 is a perspective view of the container of FIGS. 1 to 3 showing the bottom of the container;

FIG. 5 is a perspective showing a solid bottom of a container with no holes, threaded holes, receptacles, channels, windows, etc.;

FIG. 6 is a view of a mounting bracket attached to the container also with a base tray attached;

FIG. 7 is a view of a container attached to a railing or post with a base tray attached;

FIG. 8 is container supported on a stand, wherein the container has attached to it a mounting bracket, a holding bracket (supporting a test tube) and a shelf;

FIGS. 9A and 9B show different views of a container with a plant inside of it and a custom shelf supporting a plate attached via the channels;

FIG. 10 shows a container with eyelet bolts in the channels;

FIG. 11 shows the container of FIG. 10 hanging from a hook mounted on a wall and having a bottom receptacle with female threads containing a male threaded eyelet bolt;

FIGS. 12A through 12C show different views of a container with T-bolts in channels resting on the edge of another container;

FIGS. 13A through 13C show different views of a container with a magnet attachment in a channel;

FIG. 14 shows two containers connected to each other;

FIGS. 15A through 15C show one embodiment of a container connector device, which is also shown in FIG. 14;

FIGS. 16A through 16D show different perspectives of a container connector device body with double open ends;

FIGS. 17A and 17B show a container with an eyelet bolt connected to a receptacle in the container to support hanging items;

FIG. 18 shows a container with a suction cup as an accessory inserted and/or threaded into a receptacle; and

FIGS. 19A through 19C are different perspectives of a rectangular-shaped container according to the present invention.

### DETAILED DESCRIPTION OF THE INVENTION

The following describes example embodiments in which the present invention may be practiced. This invention, however, may be embodied in many ways, and the description provided herein should not be construed as limiting in any way. Among other things, the following invention may be embodied as methods or devices. The following detailed descriptions should not be taken in a limiting sense.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Within the context of this invention, the word “attachment” 50 (noun) has its generally accepted definition of a physical connection by which one thing is attached to another. As such, an attachment 50 is anything that is connected to a container 1 according to the present invention. Attachments 50 include accessories 51, hardware 70 or a combination of an accessory(ies) 51 and hardware 70. An accessory 51 to a container 1 is anything that is connected to the container 1 that contributes beauty, convenience, effectiveness or additional utility to the container 1, including but not limited to a tray, handle, mounting bracket, holding bracket, shelf, other types of brackets, easel, stand, lighting, holder, vase, cup holder, plate holder, bottle holder, electronic device, fan, writing surface, pamphlet or paper holder, mount, camera, speaker, beacon, gardening tool, handle, ornament, decoration, floor pads, legs, feet, etc. Hardware 70 is any fitting, tool, utensil, part of a machine, or physical component including but not limited to container connector devices 74, bolts (such as T-bolts and eyelet bolts), nuts, screws, wheels, casters, suction cups, hooks, knobs, etc. Attachments 50 may connect to a channel 30 on a container 1 or to a receptacle 40. Accessories 51 and hardware 70 can be comprised of custom and/or off-the-shelf components depending on the nature of the accessory 51 or hardware 70. However, it will be apparent to one skilled in the art that, due to the novel nature of the containers 1 and channels 30 of the present invention, many accessories 51 are custom made and designed to work with the unique attributes of the containers 1, channels 30, receptacles 40, and container systems 100 of the present invention. Hardware 70 on the other hand can be comprised of off-the-shelf components but custom hardware 70 can be designed to facilitate any potential uses or structures of the containers 1, channels 30, attachments 50, receptacles 40, and container systems 100 of the present invention.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

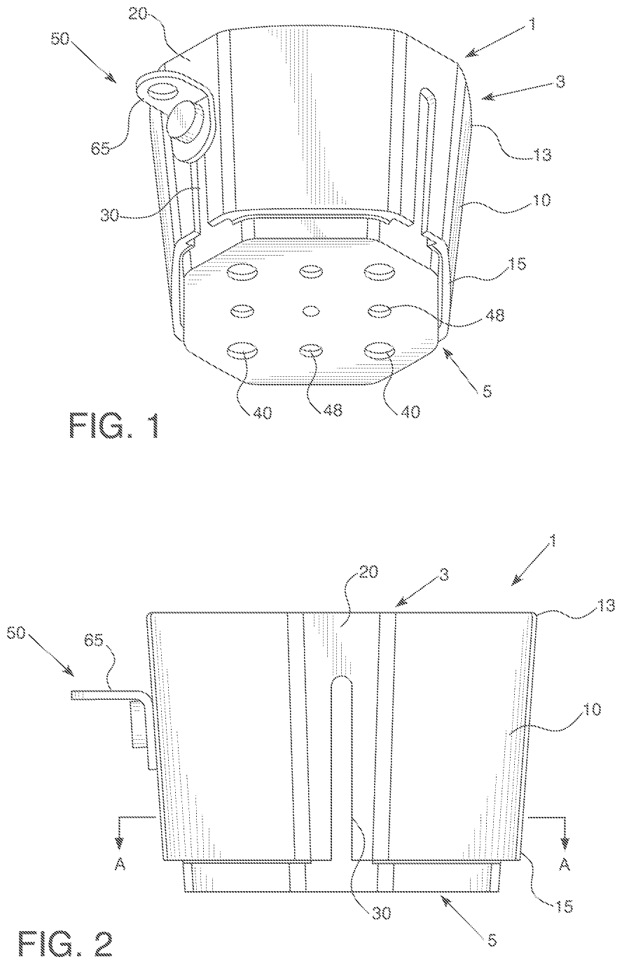

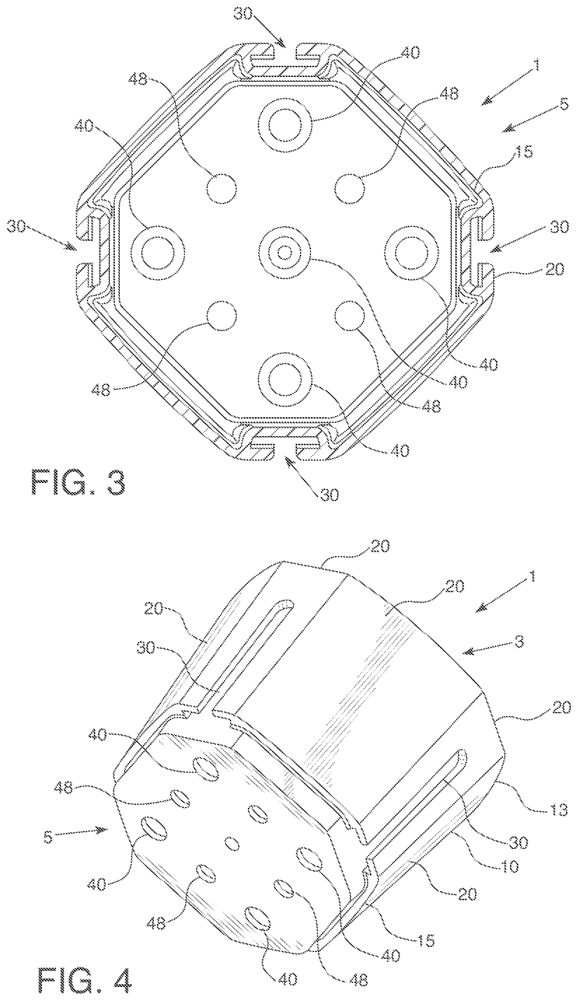

FIGS. 1 through 5 show various perspectives of one container 1 according to the present invention having an open top 3, a predominately closed bottom 5 and a circumferential sidewall 10, wherein the circumferential sidewall 10 has a top edge 13 and a bottom edge 15. Additionally, at least one channel 30 runs at least partway up the circumferential sidewall 10 starting from near the bottom edge 15 of the circumferential sidewall 10. This channel 30 can be of any length to satisfy its purpose. Additionally, the channel's depth, width and shape are dictated by the intended use of the channel 30 including the design of any attachments 50 to be used with the channel 30. In the preferred embodiment of the invention, this channel 30 has a T-shaped profile that can receive various hardware 70 and/or accessories 51 or it can be used to hang or secure the container 1. The container 1 shown in FIGS. 1 through 5 has four channels 30 (as shown most clearly in FIG. 3); however, a container 1 according to the present invention will have at least one channel 30.

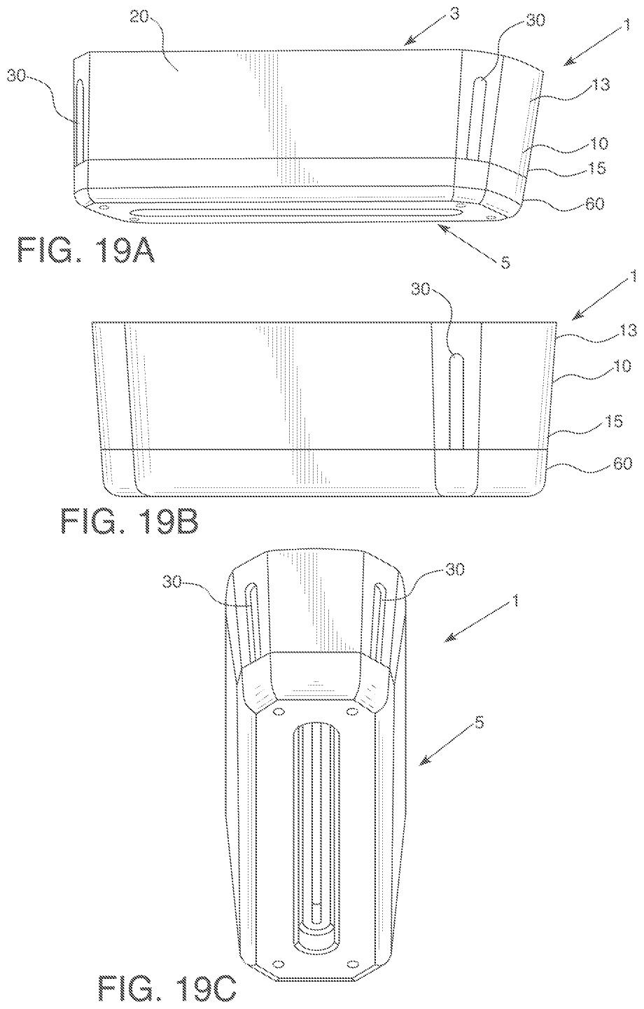

Containers 1 according to the present invention can come in any predetermined shape or size, including but not limited to having a cross-sectional shape of a circle, oval, triangle, square, pentagon, hexagon, heptagon, octagon, etc. In this respect, where the cross-section of the circumferential sidewall 10 is a geometric shape with three or more sides, the circumferential sidewall 10 can be comprised of three or more defined panels 20 with a flat or curved inner or outer surface(s). For certain embodiments and intended uses of the present invention, having at least one flat surfaced panel 20 designed with an embedded channel 30 will enable a smoother and potentially closer connection between the container 1 and the attachment 50 and/or between the container 1 and a support structure 140, such as a wall. FIGS. 1 through 5 show a container 1 with eight side panels 20—four panels 20 with a larger width and four panels 20 with a smaller width—with a cross-sectional shape of an octagon. However, as exemplified by FIGS. 19A through 19C, containers 1 can have circumferential sidewall(s) 10 of different dimensions to define an almost infinite variety of sizes and shapes for the containers 1. Additionally, containers 1 according to the present invention may have optional channel(s) 30 and/or receptacle(s) 40 along the bottom 5 of the container 1, instead of or in addition to channel(s) 30 along the sidewall(s) 10, to receive one or more attachment(s) 50 (as shown in FIGS. 11, 17A, 17B and 18).

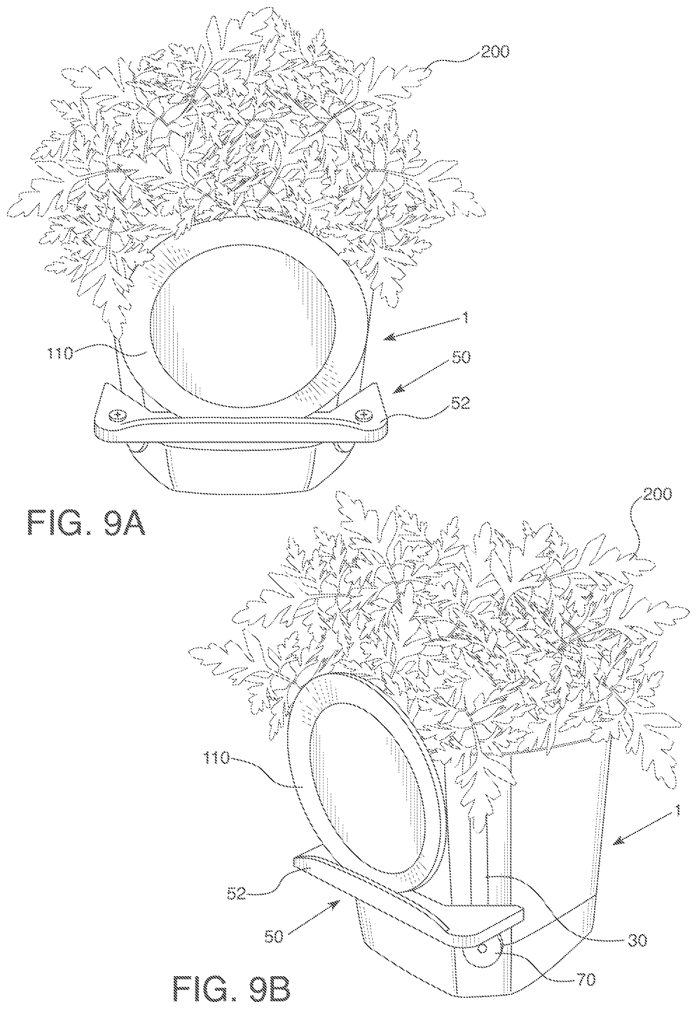

Some non-limiting examples of uses of the present invention are for holding plants 200 in various growing mediums such as soil, sand, rocks, mulch, hydropic systems or storing tools/hardware in the interior opening with accessories 51 that hold tools, reels, labels, etc. on the exterior. One such use is shown in FIGS. 9A and 9B where the container 1 is designed to hold a plant 200 inside of the container 1 and has a shelf structure accessory 51 connected to two channels 30 to hold items for display, such as the plate 110 as shown. The present invention's ability to secure containers 1 to surfaces facilitates having stationary containers 1 on non-stationary structures such as vehicles, boats, planes, etc.

The channels 30 according to the present invention are designed to receive hardware 70, such as T-bolts, that can be used on their or to connect different accessories 51 to the container 1. Alternatively, attachments 50 may be designed to connect directly to the channels 30 without the use of separate hardware 70. FIG. 6 shows a container 1 according to the present invention with a mounting bracket 54 attached via two channels 30. The combination of a container 1 with an attachment 50 creates a container system 100 according to the present invention.

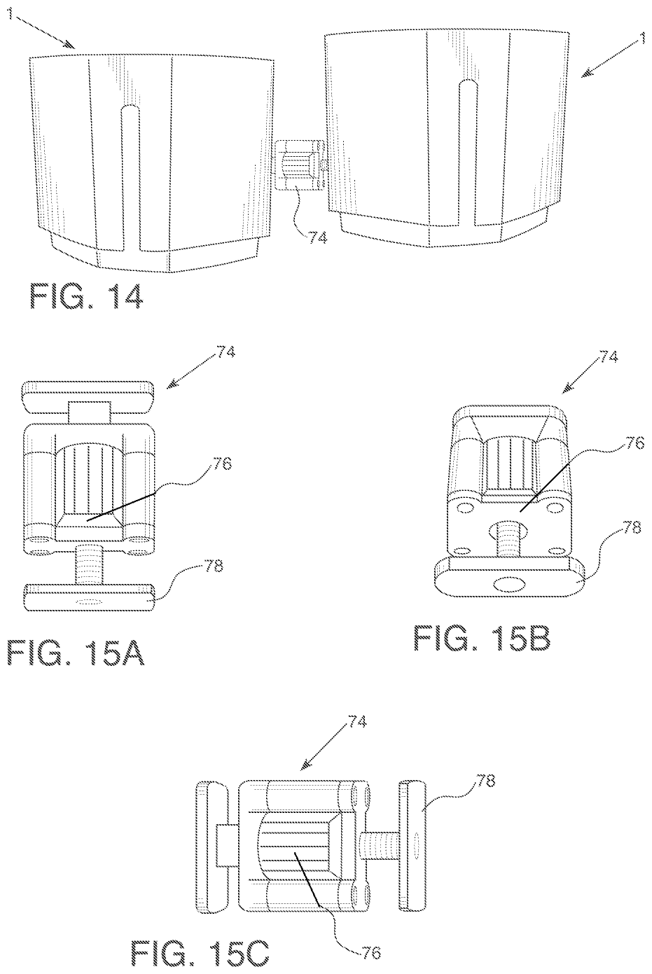

As shown in FIG. 14, the containers 1 themselves can be attached to one another through hardware 70 using the channels 30. One method of connecting multiple containers 1 to each other is to use a novel container connector device 74. One embodiment of a container connector device 74 of the present invention is a novel device having a body section with two opposing ends, wherein each end is of a predetermined size and shape to fit into a channel 30. One embodiment of a container connector device 74 is designed to have the two opposing ends in static positions, such that the ends are not able to be moved or adjusted. A container connector device 74 according to this design holds two containers 1 adjacent to one another at a space determined by the static dimensional length of the container connector device 74.

An alternative container connector device 74 according to the present invention is designed to tighten or pull one container 1 closer to or towards a second container 1 (or, alternatively, to move one container 1 farther apart from another, connected container 1.) In one embodiment, the container connector device has a T-shaped nut 76 in the body section (or an integral threaded section) and a threaded knob 78 on at least one of the first and second ends, whereby turning the knob 78 either pulls the two containers 1 closer together or moves the two containers 1 further apart. For such an embodiment, a first end is comprised of a threaded T-bolt 78 type structure that screws into a threaded nut 76 designed as a part of the body of the container connector device 74. The embodiment of this structure is illustrated in FIGS. 15A through 15C. This design enables the container connector device 74 to pull one container 1 towards the second container 1 by tightening the T-bolt structure 78 into the threaded nut structure 76.

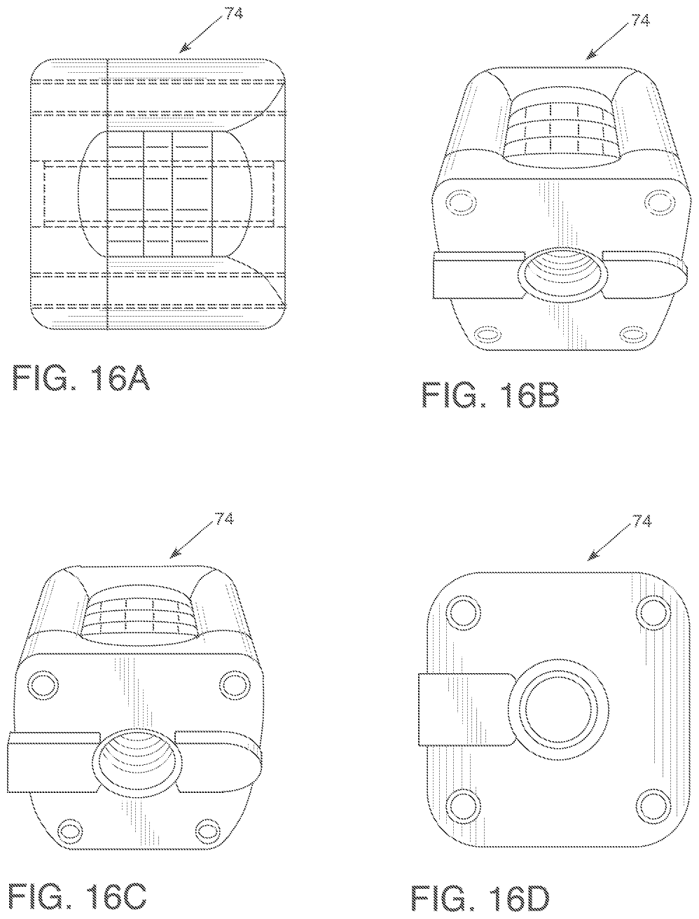

A third alternative structure for a container connector device 74 has both opposing ends made of movable parts such as two threaded T-bolts 78, each of which connects to a threaded nut structure 76 in the body of the container connector device 74. The body of this design embodiment is illustrated in FIGS. 16A through 16D. This design enables the tightening of both of bolts 78 to pull two containers 1 closer to each other. The body of this alternative structure also can be designed as a housing that holds female threaded thumb wheels. When the thumb wheels are turned, then T-nut mail threads move the nuts thereby controlling the distance of the two opposing containers 1 from one another.

In general, though, a container connector device 74 will have a body with two opposing ends. At least one of the ends, but usually both, will be of a predetermined size and shape to fit into a channel 30 on a container 1. Alternatively, the channel 30 may be of a predetermined size and shape to accommodate the container connector device 74 (or any attachment 50). When both ends of a container connector device 74 are sized and shaped to fit into channels 30 then they can be used in conjunction with the channels 30 on two different containers 1 to connect two containers 1 together.

FIGS. 15A through 15C illustrate one type of container connector device 74 according to one embodiment of the present invention. This embodiment of a container connector device 74 is what is used to hold together the containers 1 shown in FIG. 14. FIG. 15A depicts one side of one embodiment of a container connector device 74 as a T-shaped nut 76. For that embodiment, there is one threaded knob 78 in the middle of the assembly that tightens the T-shaped nut 76. This action pulls two containers 1 together (the reverse movement can occur as well). FIG. 16A depicts a second embodiment of a container connector device 74 designed to receive two threaded knobs 78 that tighten two T-shaped nuts 76 when they are screwed into both ends, which in-turn pulls two containers 1 together. FIGS. 16A through 16D show different perspectives of another embodiment of a container connector device 74 with double open ends. Any appropriate number of small containers 1 can be supported by large containers 1 using the channels 30 and connector devices 74. Similarly, any number of any size containers 1 may be connected together depending upon the design of the individual containers 1, channels 30, and container connector devices 74.

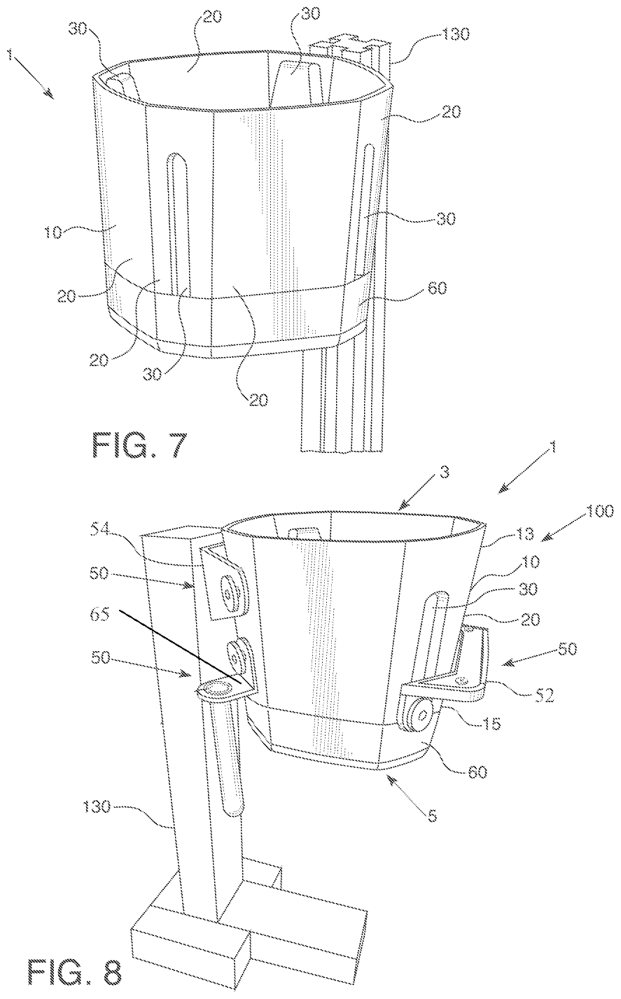

A system of multiple containers 100 can be designed by combining two or more containers 1 with at least one connector device 74. Alternatively, a system of containers 100 and support structures 140 may be designed by using at least one container 1, at least one support structure 140 and at least one attachment 50 designed to connect the container 1 to the support structure 140. This system of container(s) 100 and support structure(s) 140 can be designed to stack multiple containers 1 vertically or horizontally. The connection of the container(s) 1 to the frame or support structure 140 is accomplished by using at least one channel 30 and at least one piece of hardware 70 to achieve the connection. Examples of how the channels 30 and hardware 70 can be used to support the containers 1 are shown in FIGS. 7, 8, 11, 12A through 12C, and 13A.

The containers 1 can come in a variety of sizes and shapes as previously discussed and can be made from a wide variety of materials. The material from which the container 1 and/or the attachment 50 is made will be dictated by the intended use, cost, method of manufacture, desired weight or strength, etc. The invention can be made of plastic, metal, or any other materials that can be cast, machined, printed, blown, pressed, stamped, and/or molded. Printing in plastic, metal, wood composites, etc. allows for custom shapes, logos, text, etc. to be added to the container 1 as desired.

The channel(s) 30 can be molded, printed, cast, machined etc. as an inherent part of the sidewall 10 of the container 1. Alternatively, the channel(s) 30 can made from a material that is different from the container sidewall 10. The channel size, shape and geometry can vary according to the material from which the container 1 and/or the attachment 50 is made will be dictated by the intended use, cost, method of manufacture, desired weight or strength, etc.

The containers 1 according to the present invention can be used for a wide variety of purposes. One such exemplary purpose, is to house a plant. Typically, for containers 1 that are intended for plant growth, soil, stones, peat, water (for hydropic growing), growth medium, etc. is placed in the container's interior with a plant 200 placed into these materials. Devices to add water, light, etc. to plant(s) 200 can be mounted on the exterior of the invention by connecting the attachment 50 via a channel(s) 30. Ornamental accessories 51 can be added to the exterior of the invention for advertising, decorating, and modifying/changing aesthetic exterior appearance. Trellises and cages can easily interface with the channels 30. The trellises and cages function as protection to the plants 200 or various good/items during transporting and shipping processes. The trellises and cages can be used as growing path supports and protection from pests/vermin and hold or be an easy means to attached cloth and covers to protect against or utilize the environment such as frost/freezing temperatures and greenhouse effect applications.

In the transporting and shipping processes, the channels 30 and receptacles 40 (discussed more fully herein) provide interface points for quick handle attachment 50 and mounting to platforms such as skipping skids (screw through the skids or plates the tighten to skid rows) to prevent tipping of container 1 and facilitate easy movement/logistics.

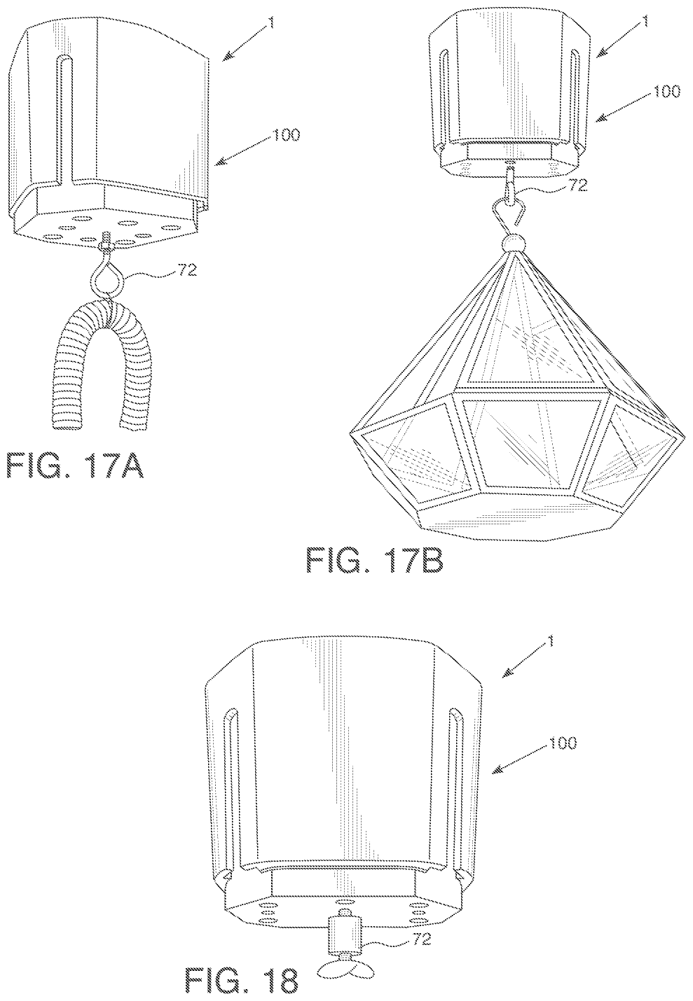

One embodiment of the present invention includes the addition of one or more receptacles 40 on the bottom 5 of the container 1. These receptacle(s) 40 can be threaded receptacles 40 or in-molded, heat staked, ultrasonically welded, printed, cast, etc. In one embodiment of the present invention, the receptacles 40 are designed as embedded female nuts (threaded receptacles 40). The receptacles 40 are novel in that they facilitate quick and expedient attachment of numerous attachments 50 to the bottom 5 of the container 1 and provide a simple means to hang other containers 1 from one another. The receptacles 40 also allow for easily replacement of attachments 50 such as caster wheels, scuff pads, standoffs, suction cups, elevating rods and poles, fixed attachment for screw and bolted installation, etc., as shown in FIGS. 17A, 17B and 18.

For the plant housing example embodiment, the bottom 5 of a container 1 can be designed to have only receptacles 40, only drainage holes 48, both or neither. Receptacles 40 can function as drainage holes 48 when they are unobstructed. Drainage holes 48 generally will be designed into containers 1 that are intended to hold plants 200. A container 1 for a plant 200 may have one or more drainage holes 48 in the bottom 5 to allow for the drainage of excess water from the growing medium. Drainage holes 48 for that purpose are holes that extend through the bottom 5 of the container 1 to allow for the passage of fluid. These drainage holes 48 are distinguishable from receptacles 40, which are intended to receive hardware 70 and/or accessories 51.

Any container 1 may have one or more receptacles 40. A container 1 according to one embodiment of the present invention will have one or more receptacles 40 that have a permanent threaded female nut molded into them for casters (ideally, four locations for wheels).

Another embodiment of the present invention has a container 1 with one or more receptacles 40 that have a permanent threaded female nut molded into them for quick attachment of a tray 60. Still another embodiment of the present invention comprises a container 1 having one hole containing a molded in threaded insert (female nut or receptacle 40) to receive a male threaded bolt to hold a tray 60 or other accessories 51 (as shown in FIGS. 17 and 18) onto the container 1.

The invention, particularly when used to hold a plant 200, often has a removable tray 60 as an accessory 51, as shown in FIG. 6, that can be used for collecting drainage from the container 1. The tray 60 can attach to the container 1 with a releasable thumb screw, snap features, pogo pins, detents, installed (typically molded in or ultrasonically welded/heat staked threaded inserts), or magnets.

Referring now in more detail to the figures, FIG. 1 illustrates, a container 1 with channels 30 for attaching an attachment 50 (accessory 51 and/or hardware 70). This attachment 50 can be connected by various forms of custom and commercially available hardware 70 or it may directly connect to the channel 30. The attachment 50 shown in FIGS. 1 and 2 is a holding bracket 65 with two holes, one to mate to the container 1 and another hole to connect to an infinite number of devices of a wide variety of sizes, shapes, and purposes. This depiction of attachments 50 shall not be in any way construed as a limitation to the variety of accessories 51 that could be attached to the container 1. Finally, the container 1 shown in FIG. 1 has both receptacles 40 and drainage holes 48 on its bottom 5.

FIG. 2 depicts a front or side view of the container 1 of FIG. 1 showing a threaded thumb wheel holding the holding bracket 65 to the channel 30. Not shown, but usable with various embodiments of the present invention, are commercially available threaded nuts that slide into the channel(s) 30 to receive the thumb wheel, bolt or other hardware 70. Letters A in FIG. 2 show the cross-section of the container 1 that is depicted in FIG. 3. FIG. 3 illustrates one possible channel geometry. FIG. 3 also shows a bottom 5 having a variety of receptacles 40 and drainage holes 48.

FIG. 4 depicts the bottom 5 of the container 1 from FIGS. 1 through 3 in a projected view. The container 1 may have receptacles 40 for receiving attachments 50. This location may also include receptacles 40 for receiving attached caster wheels, section cups, eyelets for rope, cable, string, macrame, etc. to the container 1 (examples of which are shown in FIGS. 11, 17A, 17B and 18). The container 1 can be designed to have a center receptacle 40 with a threaded insert to attach a tray 60 to the container 1 (as shown in FIGS. 6 through 8). The container 1 may have through holes 48 in the bottom 5 for drainage or rods/poles to extend through the container 1 so containers 1 can be “vertically stacked” over one another in a modular system 100.

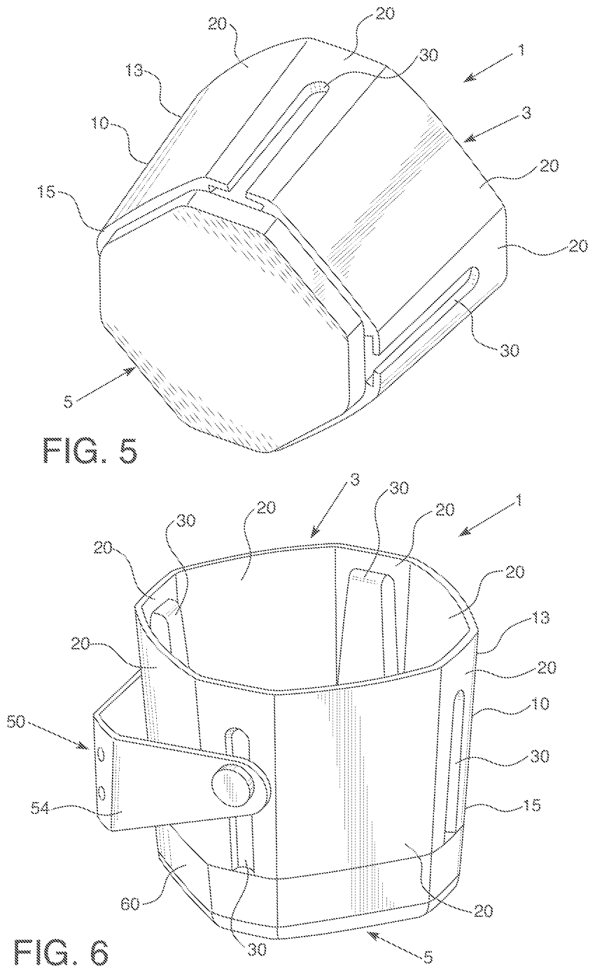

FIG. 5 illustrates one embodiment of the invention wherein the container 1 has a solid bottom 5. Any container 1 according to the present invention can be designed with a bottom 5 that has receptacles 40, holes 48, neither or both.

FIG. 6 illustrates a container 1 having an accessory mounting bracket 54 attached to two channels 30. A mounting bracket 54 may be designed to be any size or shape and made of any material. The mounting bracket 54 can connect to one or more than one channel 30.

FIG. 7 shows a container 1 connected to a support structure 140 via a single channel 30. FIG. 8 depicts a custom mounting bracket 54 that connects to two channels 30 on the container 1 and then connects the container 1 to a support structures 140. FIG. 8 also illustrates how multiple attachments 50 can connect to a single channel 30 at the same time. In FIG. 8, one end of the mounting bracket 54 is using the same channel 30 as the holding bracket 65. When the container 1 is attached to a support structure 140, an optional tray 60 can be used to hold liquids such as water that drains through any drainage holes 48. This tray 60 can be removed to discard drainage liquids easily while leaving container 1 attached to the support structure 140.

Two embodiments of support structures 140 are shown in FIGS. 7 and 8. However, support structures 140 can be an infinite number of things, including but not limited to, walls, railings, buildings, furniture, rope, cables, posts, rods, boards, beams, etc. The channel 30 and the receptacles 40 provide simple mechanisms to attach the container 1 to various support structures 140.

FIGS. 9A and 9B illustrate different views of one embodiment of the present invention. According to this embodiment, an accessory shelf 52 is attached to the container 1 using hardware 70 and two channels 30. As shown, this shelf 52 is used to support a plate 110. A plant 200 is housed inside this container 1.

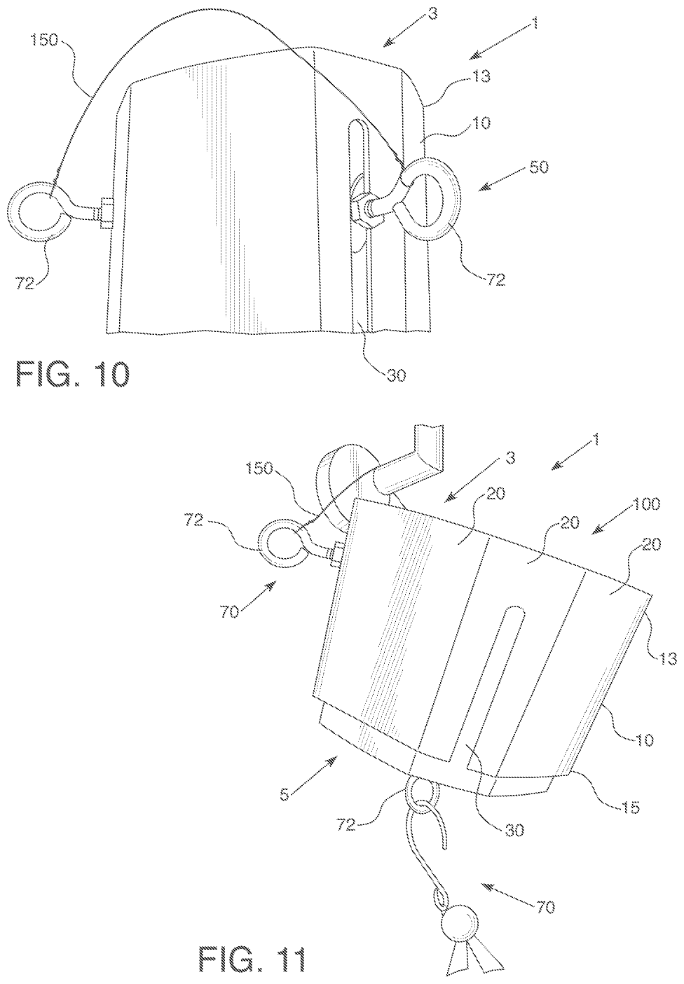

FIG. 10 shows a container 1 according to one embodiment of the present invention with eyelet bolts 70 in two channels 30. A string, wire, rope or cable 150 runs between the eyelet bolts 70. This string, etc. 150 can be used to hang this container 1 or to hang other things from the container 1. FIG. 11 illustrates how a string, wire, cable, or rope, etc. 150 when attached to the eyelet bolts 70 is used to hang the container 1 from a hook. FIG. 11 also illustrates a receptacle 40 in the bottom 5 of the container 1 that supports an eye (hardware 70) from which a hook is hanging.

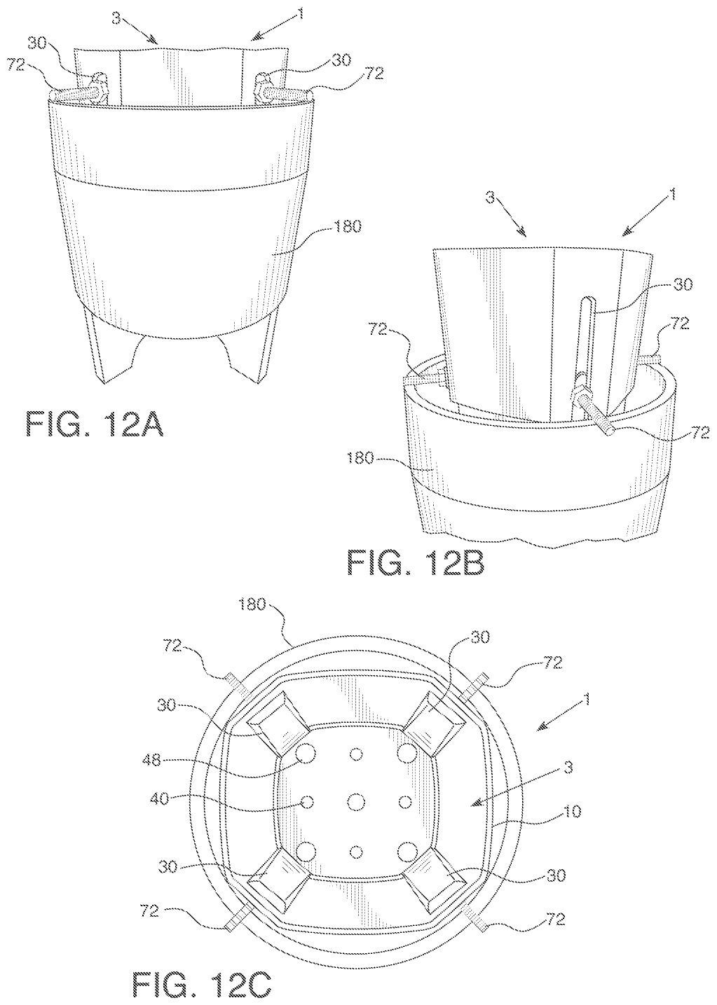

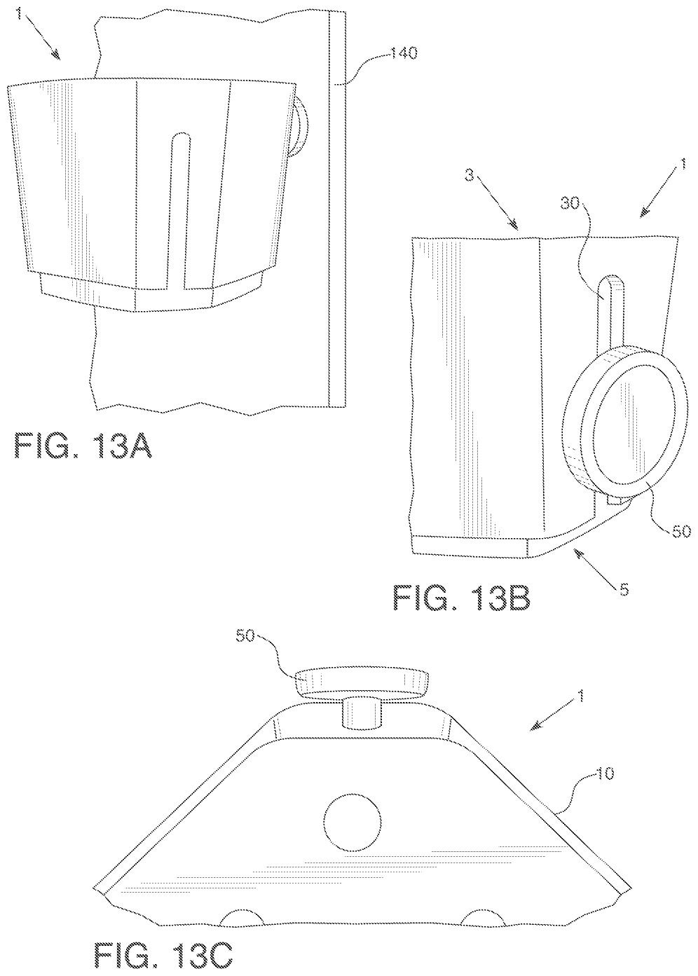

FIGS. 12A through 12C show different perspectives of a container 1 with T-bolts 70 in the channels 30. The T-bolts can be used to support the container 1 above or inside a separate pot 180. FIGS. 13A through 13C show a magnet 50 attached to a container 1 using a channel 30.

The magnet 50 can be used to attach things to the container 1 or to mount the container 1 onto another surface or wall. It will be obvious to one skilled in the art that there are numerous accessories 51 that can be attached to the containers 1 using the channels 30 and numerous ways to use the channels 30 to connect the containers 1 to other surfaces. All such combinations are included within the scope of the present invention.

Another embodiment of the present invention is a container system 100 comprising a container 1, having a top 3 with an opening; a bottom 5; and a circumferential sidewall 10, wherein the circumferential sidewall 10 has a top edge 13, a bottom edge 15 and at least one channel 30 extending up the circumferential sidewall 10 and wherein the at least one channel 30. The system 100 according to this embodiment also comprises at least one attachment 50 of a predetermined size and shape to connect to the at least one channel 30. The containers 1, channel(s) 30 and attachments 50 of this systems 100 can have all of the variations and modifications previously described. The channel 30 can have a T-shaped profile or any profile shape appropriate for the use and attachment 50. The container(s) 1 of this system 100 can have at least one receptacle 40 on the bottom 5 of the container 1 sized to receive an attachment 50. It can also have drainage holes 48. The attachments 50 for these systems can be any of the already described attachments 50 including but not limited to all options for an accessory 51, hardware 70, or a combination of an accessory 51 and hardware 70. The container 1 of this system 100 can also have a tray 60. Additionally, container systems 100 can utilize one or more container connector devices 74 (each having a first end and an opposing second end on either side of a body section and wherein the first end and the second end are each sized and shaped to fit in the at least one channel on a container to connect two containers together).

It will be obvious to those skilled in the art that the various attributes of the present invention can be combined in a variety of ways and all such combinations remain within the scope of the invention.

What is claimed is:

1. A container comprising:
a top with an opening;
a bottom; and
a circumferential sidewall, wherein the circumferential sidewall has a top edge, a bottom edge and at least one channel extending up the circumferential sidewall.

2. The container of claim 1 wherein the at least one channel is of a predetermined size and shape to receive an attachment.

3. The container of claim 1 wherein the at least one channel has a T-shaped profile.

4. The container of claim 1 wherein the circumferential sidewall defines a shape selected from the group consisting of a circle and an oval.

5. The container of claim 1 wherein the circumferential sidewall is comprised of three or more panels which define a closed cross-sectional shape.

6. The container of claim 1 also comprising at least one receptacle on the bottom of the container of a predetermined size to receive an attachment.

7. The container of claim 2 wherein the attachment is selected from the group consisting of an accessory, hardware or a combination of an accessory and hardware.

8. The container of claim 7 wherein the accessory is selected from the group consisting of one or more of a tray, mounting bracket, holding bracket, shelf, a bracket, an easel, a stand, a light, a holder, a vase, a cup holder, a plate holder, a bottle holder, an electronic device, a fan, a writing surface, a pamphlet, a paper holder, a mount, a camera, a speaker, a beacon, a gardening tool, a handle, an ornament, a decoration, a floor pad, a leg and a foot.

9. The container of claim 7 wherein the hardware is selected from the group consisting of one or more of a fitting, a tool, an utensil, a part of a machine, a physical component, a bolt, a nut, a screw, a wheel, a caster, a suction cup, a hook, a container connector device, and a knob.

10. The container of claim 2 wherein the attachment is designed to connect the container to a support structure.

11. A container system comprising:
a container comprising a top with an opening; a bottom; and a circumferential sidewall, wherein the circumferential sidewall has a top edge, a bottom edge and at least one channel extending up the circumferential sidewall; and
an attachment of a predetermined size and shape to connect to the at least one channel.

12. The container system of claim 11 wherein the at least one channel has a T-shaped profile.

13. The container system of claim 11 wherein the circumferential sidewall defines a shape selected from the group consisting of a circle and an oval.

14. The container system of claim 11 wherein the circumferential sidewall is comprised of three or more panels which define a closed cross-sectional shape.

15. The container system of claim 11 also comprising at least one receptacle on the bottom of the container of a predetermined size to receive an attachment.

16. The container system of claim 11 wherein the attachment is selected from the group consisting of an accessory, hardware or a combination of an accessory and hardware.

17. The container system of claim 16 wherein the accessory is selected from the group consisting of one or more of a tray, mounting bracket, holding bracket, shelf, a bracket, an easel, a stand, a light, a holder, a vase, a cup holder, a plate holder, a bottle holder, an electronic device, a fan, a writing surface, a pamphlet, a paper holder, a mount, a camera, a speaker, a beacon, a gardening tool, a handle, an ornament, a decoration, a floor pad, a leg and a foot.

18. The container system of claim 16 wherein the hardware is selected from the group consisting of one or more of a fitting, a tool, an utensil, a part of a machine, a physical component, a bolt, a nut, a screw, a wheel, a caster, a suction cup, a hook, a container connector device, and a knob.

19. The container system of claim 11 wherein the attachment is designed to connect the container to a support structure.

20. The container system of claim 11 wherein the attachment is a container connector device having a first end and an opposing second end on either side of a body section and wherein the first end and the second end are each of a predetermined size and shape to fit in the at least one channel on a container to connect two containers together.

21. The container system of claim 20 wherein the container connector device has a T-shaped nut in the body section and a threaded knob on at least one of the first and second ends, whereby turning of the knob either pulls the two containers closer together or moves the two containers apart.

22. A container connector device for connecting two containers, the device comprising, a body section;
two opposing ends on the body section, each opposing end having a predetermined size and shape to connect to a channel in a sidewall of a container.

23. The container connector device of claim 22, wherein at least one of the two opposing ends is movably connected to the body such that the at least one of the two opposing ends can be operated to pull the attached container closer to the body of the container connector device.

24. The container connector device of claim 23, wherein the at least one movably connected end of the two opposing ends is a threaded T-bolt that connects to the body section through a threaded nut structure in the body.
